(19) United States
(12) Patent Application Publication
(10) Pub. No.: US 2019/0136102 A1
(43) Pub. Date: May 9, 2019

(54) ADHESIVE COMPOSITIONS CONTAINING REACTIVE SILSESQUIOXANES

(71) Applicant: Henkel IP & Holding GmbH, Duesseldorf (DE)

(72) Inventors: Lynnette Hurlburt, Manchester, CT (US); Nigel Sweeney, Dublin (IE); Philip T. Klemarczyk, Canton, CT (US)

(21) Appl. No.: 16/185,466

(22) Filed: Nov. 9, 2018

Related U.S. Application Data
(63) Continuation of application No. PCT/US2017/031635, filed on May 9, 2017.
(60) Provisional application No. 62/333,462, filed on May 9, 2016.
(60) Provisional application No. 62/358,366, filed on Jul. 5, 2016.

(51) Int. Cl. C09J 143/04; C09J 4/00; C09J 4/06; C09J 5/06

(52) U.S. Cl. CPC C09J 143/04; C09J 5/06; C09J 4/06; C09J 4/00

(57) ABSTRACT

The present invention provides adhesive compositions, sometimes in a two part configuration which include a first part containing a (meth)acrylic component, an organic peroxide and a silsesquioxane and a second part containing a (meth)acrylic component, a nitrogen-containing compound and a metal salt.

### BACKGROUND

### Field

The present invention provides adhesive compositions, sometimes in a two part configuration which include a first part containing a (meth)acrylic component and an organic peroxide and a second part containing a (meth)acrylic component, a nitrogen-containing compound and a metal salt. In at least one of the first part or the second part, a silsesquioxane is also included.

### Brief Description of Related Technology

The use of silsesquioxane materials in polymer compositions is known. U.S. Pat. Nos. 8,794,282 and 8,642,691 (Herganrother) disclose the use of amino alkoxy-modified silsesquioxanes for use in vulcanized rubber compositions to provide adhesion to metal cord in tires. The manufacture of silsesquioxanes is generally disclosed in U.S. Pat. No. 6,972,312 (Lichtenhan). For a general discussion of processes for preparation and characterization of silsesquioxanes. See R. H. Blaney et al., Chem. Rev., 1995, 95, 1409-1430.

Acrylic-based adhesive compositions are well known. See e.g. U.S. Pat. No. 4,536,546 (Briggs). While adhesives based on this technology appear to have been sold under the tradenames PLEXUS MA 300 and 310 by Illinois Tool Works Inc., Chicago, Ill., they can exhibit an obnoxious odor and they are toxic to handle, which are significant drawbacks to their use.

The first and second parts are of sufficiently low viscosity to be easily dispensed with a pumping apparatus. To form this adhesive, the first and second parts are mixed, and immediately after mixing, the mixture is of a higher viscosity, such that the adhesive does not sag, drip, or migrate, after application to a surface within the open time of the mixture, and the mixed first and second parts cure. By the term “open time” is meant the elapsed time between the mixture of the adhesive to the curing.

Existing compositions do not possess the desired fast fixturing and good adhesion properties for the assembly of laminates, such as hand held display devices.

### SUMMARY

The present invention provides adhesive compositions, sometimes in a two part configuration which include a first part (A) containing a (meth)acrylic component and an organic peroxide and a second part (B) containing a (meth)acrylic component, a nitrogen-containing compound and a metal salt. In at least one of the first part or the second part, a silsesquioxane is also included.

When the first and second parts are mixed and applied to at least one substrate, the composition will have up to 5 minutes of open time and when the substrates are mated they will show a fixture time of about 5 minutes of less at about room temperature (23° C.) at which point the mated assembly can support 3 kg load.

More specifically, a two part adhesive composition is provided that includes:
(a) a first part including a (meth)acrylic component and an organic peroxide; and
(b) a second part including a (meth)acrylic component, a nitrogen-containing compound and a metal salt, where in at least one of the first part or the second part, a silsesquioxane is also included.

In another aspect of the invention there is provided a method of preparing a two-part adhesive composition which includes:
(a) forming a first part (A) including a (meth)acrylic acid component and an organic peroxide; and
(b) forming a second part (B) including a (meth)acrylic acid component, a nitrogen-containing component and a metal salt, where in at least one of the first part or the second part, a silsesquioxane is also included.

In yet another aspect of the invention there is provided a method of bonding a first surface to a second surface, which includes the step of:

providing a two part composition which includes:
(a) a first part (A) including a (meth)acrylic component and an organic peroxide; and
(b) a second part (B) including a (meth)acrylic component, a nitrogen-containing compound and a metal salt, where in at least one of the first part or the second part, a silsesquioxane is also included;

providing a first surface and a second surface in a mating relationship and disposing the composition between the mated surfaces. When the first and second parts are mixed and applied to at least one surface, the composition will have up to about 5 minutes of open time and when the surfaces are mated they will have a cure time of about 20 minutes or less at 80° C. and a fixture time of less than 5 minutes at which the bond will support 3 Kg.

In another aspect, the present invention there is provided an adhesive composition which includes:
(a) a (meth)acrylic component;
(b) a curative package comprising an organic peroxide, a nitrogen-containing compound and a metal salt; and
(c) a silsesquioxane component.

### BRIEF DESCRIPTION OF THE FIGURES

FIG. 1 is a graph showing the results of cross bond tensile tests on IXEF lap shears demonstrating the enhanced adhesive strength of the inventive compositions.

FIG. 2 is a graph showing the results of tensile tests on mild lap shears demonstrating the enhanced adhesive strength of the inventive compositions.

FIG. 3 is a graph showing the results of tensile tests on stainless steel lap shears demonstrating the enhanced adhesive strength of the inventive compositions.

FIG. 4 is a graph showing the results tensile tests on aluminum lap shears demonstrating the enhanced adhesive strength of the inventive compositions.

FIG. 5 is a graph showing the results of shear tests on glass blocks demonstrating the enhanced adhesive strength of the inventive compositions.

FIG. 6 is a graph showing the results of tensile tests on Lexan (polycarbonate) lap shears demonstrating the enhanced adhesive strength of the inventive compositions.

FIG. 7 is a graph showing the results of tensile tests on PC-ABS lap shears demonstrating the enhanced adhesive strength of the inventive compositions.

FIG. 8 is a graph showing the results of tensile tests on nylon lap shears demonstrating the enhanced adhesive strength of the inventive compositions.

FIG. 9 is a graph showing the results of complex modulus measurements of adhesive compositions of the present invention.

FIG. 10 is a graph showing the results of tensile tests on multiple substrates (and push test or cross bond test on IXEF) for certain POSS additives at a 0.25% by weight amount in Part B of the inventive composition.

### DETAILED DESCRIPTION

The adhesive compositions of this invention provide enhanced adhesion to substrate surfaces constructed from a variety of materials, many of which are metallic.

The present invention therefore provides adhesive compositions, sometimes in a two part configuration which include a first part (A) containing a (meth)acrylic component and an organic peroxide and a second part (B) containing a (meth)acrylic component, a nitrogen-containing compound and a metal salt. A silsesquioxane is present in at least one of the first part or the second part.

In one particularly useful aspect of the invention, the silsesquioxane contains one or more reactive groups attached thereto. The functional groups on the silsesquioxane may be (meth)acryloxyalkyl groups, or a combination of silanol and cyclohexyl groups as further described herein. Other useful reactive functional groups are also described. The reactive functional groups on the silsesquioxane provide the adhesive composition with enhanced adhesion to substrate surfaces, as well as the ability to tailor compatibility with various other components in the adhesive composition.

Among the substrate surfaces where enhanced adhesion and bonding strength is achieved includes metals, such as mild steel, stainless steel and aluminum, glass substrates, and various plastic substrates, such as acrylics, polycarbonate, polycarbonate-ABS and nylon.

The combination of the first part (A) and the second part (B) results in an adhesive composition that cures and when disposed between two surfaces mates adhesively one surface to the other surface. After curing, the composition forms an adhesive bond between the two surfaces.

While the two part compositions may be used in a variety of commercial applications, they are particularly useful in the assembly of electronic display devices, such as hand-held phone and computer devices.

Part (A)

(Meth)Acrylic Components

Any suitable material which contains at least one group having the following formula:

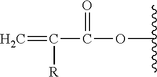

where R is selected from H, halogen, or C₁ to C₁₀ hydrocarbyl, may be used.

Advantageously, the group is a (meth)acryloxy group. The term “(meth)acryloxy” is intended to refer to both acrylate and methacrylate, in which R is H or methyl, respectively. The useful amount of the (meth)acrylic component typically ranges from about 20 percent by weight to about 80 percent by weight of the total composition. Desirably, the inventive compositions contain from about 50 percent by weight to about 70 percent by weight of (meth)acrylic component.

The (meth)acrylic component may be present in the form of a polymer, a monomer, or a combination thereof. When present in the form of a polymer, the (meth)acrylic component may be a polymer chain to which is attached at least one of the above-indicated groups. The groups may be located at a pendant or a terminal position of the backbone, or a combination thereof. Advantageously, at least two such groups may be present, and may be located at terminal positions. The (meth)acrylic component may have a polymer chain, constructed from polyvinyl, polyether, polyester, polyurethane, polyamide, epoxy, vinyl ester, phenolic, amino resin, oil based, and the like, as is well known to those skilled in the art, or random or block combinations thereof.

The polymer chain may be formed by polymerization of vinyl monomers. Illustrative examples of such vinyl monomers are methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(meth)acryloyloxypropyltrimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate, ethoxylated trimethylolpropane triacrylate, trimethylol propane trimethacrylate, dipentaerythritol monohydroxypentaacrylate, pentaerythritol triacrylate, ethoxylated trimethylolpropane triacrylate, 1,6-hexanedioldiacrylate, neopentyl glycoldiacrylate, pentaerythritol tetraacrylate, 1,2-butylene glycoldiacrylate, trimethylopropane ethoxylate tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate and ethoxylated bisphenol A di(meth)acrylate. These monomers may be used each alone or a plurality of them may be copolymerized. Particularly desirable (meth)acrylate ester monomers include those where the alcohol portion of the ester group contains 1-8 carbon atoms. For instance, 2-ethylhexyl methacrylate, hydroxyethyl methacrylate, cyclohexyl methacrylate, ethyl methacrylate, 1,3-butanedioldimethacrylate (“BDMA”), butyl methacrylate and methyl methacrylate (“MMA”), are examples.

Peroxy Initiators

A class of peroxy initiators particularly suitable to the present invention is the hydroperoxy initiators. Of these, organic hydroperoxides are particularly. Particularly preferred organic hydroperoxides include, p-methane hydroperoxide, diisopropyl benzene hydroperoxide, pinene hydroperoxide, methyl ethyl ketone hydroperoxide, t-butyl-2-hydroxyethyl peroxide, t-butyl peroxymaleic acid, cumene hydroperoxide (“CHP”), tertiary-butyl hydroperoxide (“TBH”), and benzoyl peroxide (“BP”). Additionally, inorganic peroxides and compositions such as peroxy esters as for example t-butyl perbenzoate, benzophone peroxyesters and fluorenone peroxyesters, peroxy carbonates and halogen containing compounds having electronic structures which facilitate free radical formation, esters which decompose to form free radicals are also useful. The term “peroxy” is intended to mean peroxides, hydroperoxides and peresters which are suitable for preparing anaerobically curing system.

The peroxy polymerization initiators may be used in the compositions of the present invention in amounts sufficient to perform their initiation function. Useful, non-limiting amounts include about 0.01 percent by weight to about 10 percent by weight based on the total composition, and desirably about 1.0 percent by weight to about 3.0 percent by weight based on the total composition.

Block Copolymers

When used, the block copolymer may be any block copolymer capable of contributing to the physical properties desired for the disclosed composition. The Block Copolymers may be present in either or both parts of the two part composition.

The block copolymer rubber may be constructed using blocks of either butadiene or isoprene with styrene (for example, SBS, SIS, SEBS and SB), commercial examples of which are available from Shell Chemical Co. as KRATON D-1116 and other KRATON D-grade elastomers from Dexco as VECTOR 2411IP.

Other elastomers with Tg below about 25° C., which are soluble in methacrylate/acrylate monomers, can be used in place of the block copolymer rubbers. Examples of such are the homopolymer of epichlorohydrin and its copolymers with ethylene oxide, available from Zeon Chemicals as HYDRIN, acrylate rubber pellets, available from Zeon as HYTEMP, polyisoprene rubber, polybutadiene rubber, nitrile rubber, and SBR rubber (random copolymer of butadiene and styrene).

Still other block copolymers may be a styrene maleic anhydride copolymer, represented by the formula:

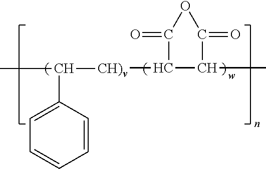

where v is from 1 to 12; w is from 1 to 6; and n is from 1 to 50.

Styrene maleic anhydride copolymers are well known and some of which are available commercially from Sartomer Company, Inc., Exton, Pa. under the trade name SMA EF80, for example. Styrene maleic anhydride copolymers represent the copolymerization product of styrene and maleic anhydride and are characterized by alternating blocks of styrene and maleic anhydride moieties.

Amphiphilic block copolymers may be particularly desirable. Arkoma offers for sale commercially an amphiphilic block copolymer under the trademark NANOSTRENGTH. Such block copolymers are currently available in two versions: SBM and MAM. The SBM copolymer is reportedly made of polystyrene, 1,4-polybutadiene and syndiotactic poly(methyl methacrylate).

In addition, a polymer material constructed from polymethyl methacrylate (“PMMA”) and polybutyl acrylate (“PB”) may be used too. Polymer materials within this class are referred to as polymethylmethacrylate-block-polybutylacrylate-block polymethylmethacrylate copolymers (“MAM”).

As reported by Arkema, MAM is a triblock copolymer, consisting of about 70% PMMA and 30% PB. MAM is constructed from distinct segments, which provides for the ability to self-assemble at the molecular scale. That is, M confers hardness to the polymer and A confers elastomeric properties to the polymer.

A hard polymer segment tends to be soluble in (meth)acrylates, whereas the elastomeric segments provide toughness to the polymeric (meth)acrylate, which forms upon cure. MAM also reinforces mechanical properties, without compromising inherent physical properties. MAM is commercially available under the tradename NANOSTRENGTH, at present under several different grades—i.e., E-21 and M-52N.

Arkema promotes the NANOSTRENGTH product line as an acrylic block copolymer that is miscible with many polymers, most of which according to the manufacturer are major industrial epoxy resins. See also U.S. Pat. No. 6,894,113 (Court), where in its abstract the '113 patent speaks to a thermoset material with improved impact resistance. The impact resistance is derived from 1 to 80% of an impact modifier comprising at least one copolymer comprising S-B-M, B-M and M-B-M blocks, where each block is connected to the other by a covalent bond or of an intermediary connected to one of the blocks by a covalent bond and to the other block by another covalent bond, M is a PMMA homopolymer or a copolymer comprising at least 50% by weight of methyl methacrylate, B is incompatible with the thermoset resin and with the M block and its glass transition temperature Tg is less than the operating temperature of the thermoset material, and S is incompatible with the thermoset resin, the B block and the M block and its Tg or its melting temperature is greater than the Tg of B.

Another commercially available example of an amphiphilic block copolymer is a polyether block copolymer known to the trade as FORTEGRA 100, from Dow Chemical Co. Dow describes FORTEGRA 100 as a low viscosity toughening agent designed for use as a high efficiency second phase, in amine cured epoxy systems. FORTEGRA 100 is reported to provide improved toughness without significantly affecting the viscosity, glass transition temperature, corrosion resistance, cure rate or chemical resistance of the final coating or composition. FORTEGRA 100 is also reported to be useful for formulation into standard bisphenol A and bisphenol F epoxy systems as it does not participate in the epoxy cure reaction. As a second phase toughening agent, FORTEGRA 100 is promoted as being effective when formulated at a specific volume fraction of the finish film or part, typically 3% to 8% by dry volume is said to achieve the toughening effect.

Additional block copolymers include those which comprise both hydrophobic and hydrophilic segments or portions, of the general formula:

—[(R¹)ᵥ—(R²)_{w}]ₙ—

where here R¹ is independently a hydrophobic olefin, such as ethylene, propylene, 1-butene, 1-hexene, 3-methyl-1-pentene, or 4-methyl-1-pentene or a polymerizable hydrophobic aromatic hydrocarbon such as styrene; each R² is a hydrophilic acid anhydride, such as maleic anhydride; v is from 1 to 12; w is from 1 to 6; and n is from 1 to 50.

The ratio of the hydrophobic segments to the hydrophilic segments in the styrene maleic anhydride block copolymer may be at least 2:1, such as between 3:1 and 12:1. The hydrophilic segments in the block copolymer should comprise an anhydride, such as maleic anhydride. The hydrophobic segments in the block copolymer should comprise at least one of ethylene, propylene, 1-butene, 1-hexene, 3-methyl-1-pentene, 4-methyl-1-pentene, or styrene. Desirably, the block copolymer should be prepared with the hydrophilic segments comprising maleic anhydride and the hydrophobic segments comprising styrene.

Reference to the following U.S. patent documents shows amphiphilic block copolymers suitable for use herein, and as such are incorporated herein by reference. U.S. Pat. No. 7,745,535 (Schmidt) is directed to and claims an amphiphilic multiblock copolymer where at least one block is a profiled block consisting of a) a hydrophilic middle block made from one or more monomeric units selected from acrylic acid, methacrylic acid, and the salts, esters, anhydrides and amides of acrylic acid and methacrylic acid; dicarboxylic acid anhydrides; carboxyethyl acrylate; and acrylamides; and b) hydrophobic end blocks where the multiblock copolymer is water insoluble, water indispersible, and not soluble or dispersible in C₁₋₃ alcohols.

U.S. Pat. No. 7,820,760 (Pham) is directed to and claims a curable adhesive epoxy resin composition including (a) an epoxy resin; (b) an amphiphilic block copolymer containing at least one epoxy resin miscible block segments and at least one epoxy resin immiscible block segments (where the immiscible block segment comprises at least one polyether structure provided that the polyether structure of the immiscible block segment contains at least one or more alkylene oxide monomer units having at least four carbon atoms); and (c) at least one curing agent. The amphiphilic block copolymer in the '760 patent is an all polyether block copolymer such as a PEO-PBO diblock copolymer or a PEO-PBO-PEO triblock copolymer. The amphiphilic block copolymer is present in an amount such that when in the '760 patent the epoxy resin composition is cured, the bond strength of the resulting cured epoxy adhesive resin composition increases compared to an epoxy resin composition without the amphiphilic polyether block copolymer.

U.S. Pat. No. 7,670,649 (Hoyles) is directed to and claims a curable ambient cure high-solids coating composition including (a) an epoxy resin; (b) an amphiphilic block copolymer containing at least one epoxy resin miscible block segment (where the immiscible block segment comprises at least one polyether structure provided that the polyether structure of the immiscible block segment contains at least one or more alkylene oxide monomer units) and at least one epoxy resin immiscible block segment; and (c) a sufficient amount of a nitrogen-containing curing agent to cure the coating composition at ambient temperature of less than about 60° C. When the epoxy resin composition is cured, the toughness of the resulting cured epoxy resin composition is increased.

U.S. Pat. No. 6,887,574 (Dean) is directed to and claims a curable flame retardant epoxy resin composition including (a) at least one flame retardant epoxy resin; (b) at least one amphiphilic block copolymer; and (c) a curing agent. Such components are present in the curable composition in the appropriate amounts and ratios such that, upon curing, the block copolymer self-assembles into a nano structure morphology, such as a worm-like micelle morphology. The resulting cured product is reported to have a remarkably increased high fracture resistance; and allows the use of flame retardant epoxies in applications where fracture resistance is an issue.

U.S. Patent Application Publication No. 2008/0287595 (Verghese) is directed to a composition comprising (1) a thermosettable resin selected from an epoxy resin, an epoxy vinyl ester resin, an unsaturated polyester resin or a mixture thereof, and (2) an amphiphilic mock copolymer dispersed in the thermosettable resin. In addition, fiber-reinforced plastics (FRP), coatings and composites prepared from the composition are provided as well.

International Patent Publication No. WO 2010/008931 (Turakhia) is directed to a structural composite that uses a block copolymer toughening agent to increase the fracture resistance (toughness) of the structural composite. The structural composite comprises (i) a carbon fiber reinforcing material and (ii) a thermosettable resin composition; wherein the thermosettable resin composition comprises (a) a thermosettable resin and (b) at least one block copolymer toughening agent.

International Patent Publication No. WO 2009/018193 (Verghese) is directed to curable compositions, cured compositions, and methods of forming the same, including an epoxy resin, a curing agent, an amphiphilic toughening agent, and an inorganic nanofiller, where the toughening agent forms a second phase having at least one dimension being on the nanometer scale.

The block copolymer may be used herein in an amount up to about 50 weight percent, desirably from 5 to 40 weight percent based on the total weight of the adhesive composition.

The glass transition temperature (“Tg”) of the block copolymer should be above about 40° C. In one embodiment, the Tg of the block copolymer is between about 40° C. and about 155° C.

The Tg of a polymer is the temperature at which the polymer becomes brittle on cooling or soft on heating. More specifically, Tg defines a pseudo second order phase transition in which a polymer yields, on cooling, a glassy structure with properties similar to those of a crystalline material. Above Tg, the polymer becomes soft and capable of plastic deformation without fracture. While the Tg is occasionally described as the “softening temperature” of a polymer, it is not uncommon for the polymer to begin softening at a temperature below the Tg. This is because, due to the nature of many non-crystalline polymers, the softening of the polymer may occur over a temperature range rather than abruptly at a single temperature value. Tg generally refers to the middle point of this range even though the polymer may begin to soften at a different temperature. For purposes of this application, the Tg of a polymer refers to the value as determined by ASTM E-1356.

In addition to becoming brittle at temperatures below Tg, a polymer also generally becomes drier and less tacky than when that same polymer is heated to a temperature above its Tg. A tacky polymer will more readily adhere to a surface upon application of pressure alone than a non-tacky polymer. The importance of incorporating a copolymer that has a Tg above 40° C., and thus is dry or only slightly tacky at this point, will become more apparent by the discussion that follows.

Metal Salts

Useful metal salts include Cu(II), Nickel, Cobalt, Manganese, and Iron; at levels from 50 to 400 parts per million.

Reactive Acid Component

The inventive compositions include an acid or acid ester. Desirably, this component is only in one of the parts of the two part composition, ordinarily part (A). Suitable acids or acid esters include phosphoric acid or derivatives, phosphate acid esters, and sulfonic acids or derivatives. A preferred reactive acid component is a phosphate acid ester.

The acid monomer is a free-radical polymerizable acid monomers, such as ethylenically unsaturated mono or polycarboxylic acids, maleic acid and crotonic acid. Desirable ones include methacrylic acid (“MAA”) and acrylic acid. The reactive acid component also modulates and decelerates the curing time of the thermoset composition.

Suitable phosphate esters include those represented by the formula:

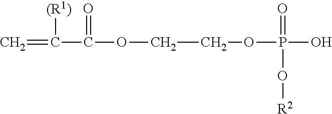

where R¹ is H or CH₃, and R² is H, or a radical represented by the structure:

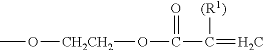

where R¹ is H or CH₃. A particularly useful phosphate ester is hydroxyl ethyl methacrylate (“HEMA”) phosphate ester, which is sold under the tradenames T-MULZ 1228 or HARCRYL 1228 or 1228M, each available from Harcross Chemicals, Kansas City, Kans. Also included are structures with at least one strong acid “active hydrogen” group, or with at least one phosphonic acid active hydrogen group (R₁R₂POOH), such as hydroxyl ethyl diphosphonic acid, phosphonic acid, and derivatives, or oligomeric or polymeric structures with phosphonic acid functionality or similar acid strength functionality.

The reactive acid component is present from about 0.25 percent by weight to about 15 percent by weight of the total composition.

Free Radical Inhibitors

Free radical polymerization inhibitors may be used in the present invention to prevent premature reaction prior to mixing.

Numerous suitable free-radical polymerization inhibitors are known in the art, and include quinones, hydroquinones, hydroxylamines, nitroxyl compounds, phenols, amines, arylamines, quinolines, phenothiazines, and the like. Particularly useful free radical inhibitors include hydroquinone, tertiary butylhydroquinone (“TBHQ”), methyl hydroquinone, hydroxyethylhydroquinone, phenothiazine, and NAUGARD-R (blend of N-alkyl substituted p-phenylenediamines, from Chemtura Corp., Naugatuck, Conn.). One or more individual free radical inhibitors may also be used in combination.

Other Additives

Additional additives may be added to either part (A), part (B) or both parts. Non-limiting examples of additional additives include fillers, core shell polymers, lubricants, thickeners, and coloring agents. The fillers may provide bulk without sacrificing strength of the adhesive and can be selected from high or low density fillers. Also, certain fillers, such as silica, can confer rheological modification or small particle reinforcements. Commercially available examples include Cab-O-Sil 610 and AEROSIL R8200.

Of particular interest are low density fillers, because the resulting final product has an otherwise lower density than a product without the filler, yet has essentially the same strength characteristics as if the filler was not present.

The core shell polymer is desirably a graft copolymer of the “core shell” type, or may also be a “shell-less” cross-linked rubbery particulate, such as acrylonitrile-butadiene-styrene (“ABS”), methacrylate-butadiene-styrene (“MBS”), and methacrylate-acrylonitrile-butadiene-styrene (“MABS”). BLENDEX 338 is an ABS powder from GE Plastics.

Part (B)

(Meth)Acrylate Component

The (meth)acrylate used in part (B) may be any one or more of the (meth)acrylates used in part (A).

Amines

The inventive compositions include at least one amine that acts as a catalyst by accelerating or otherwise promoting curing of the present inventive compositions. The amines and the peroxide are not present in same the part in order to prevent premature polymerization. For example, if part (B) contains the amine accelerator, then part (A) contains the peroxide.

The amines desirably are tertiary or sterically hindered. Suitable amines include, for example, tertiary amines represented by the formula NR₃, where R is selected from alkyl, aryl, alkaryl, or aralkyl radicals, including C₁₋₁₀ alkyl, C₆₋₁₈ aryl, C₇₋₁₅ alkaryl, and C₇₋₁₅ aralkyl radicals. Suitable hindered amines also include primary or secondary amines, such as HNR₂ or H2NR, where R is a C₄₋₁₀ alkyl. For example, alkyl groups such as tertiary butyl, or neopentyl, sterically shield the hydrogen bound to the nitrogen atom, and are suitable substituents in this component of the present invention. For either tertiary amines or secondary amines, the R groups may be linked so that the nitrogen is embedded within a cyclic structure.

Particularly useful amines for inclusion in the present inventive compositions include, for example, 1,8-diazabicyclo(5.4.0)undec-7-ene (“DBU”), 1,4-diazabicyclo(2.2.2)octane (“DABCO”), triethylamine, and substituted guanidines, such as tetramethylguanidine (“TMG”), dimethyl-p-toluidine (“DMPT”), dimethyl aniline, dihydroxyethyl aniline, dihydroxy ethyl p-toluidine, dimethyl-o-toluidine, dialkyl aniline, dialkyl toluidine and the like, acyl thiourea, benzoyl-thiourea, and aryl-thiourea.

The amine can be present in an amount from about 0.01 weight % to about 5 weight %, based on the weight of the total composition. Desirably, the amine is present in an amount from about 0.05 weight % to about 2 weight %, and more desirably, the amine is present in amounts from about 0.3 weight % to about 0.7 weight %, based on the weight of the total composition.

Plasticizers

Plasticizers may be used in either part or in both parts of the two part composition. Plasticizers may be any liquid or soluble compound that assists with the flexibility of the reactive portion of the composition and/or may act as a carrier vehicle for other components of the composition. Examples include aromatic sulfonamides, aromatic phosphate esters, alkyl phosphate esters, dialkylether aromatic esters, polymeric plasticizers, dialkylether diesters, polyglycol diesters, tricarboxylic esters, polyester resins, aromatic diesters, aromatic triesters (trimellitates), aliphatic diesters, epoxidized esters, chlorinated hydrocarbons, aromatic oils, alkylether monoesters, naphthenic oils, alkyl monoesters, paraffinic oils, silicone oils, di-n-butyl phthalate, diisobutyl phthalate, di-n-hexyl phthalate, di-n-hepytl phthalate, di-2-ethylhexyl phthalate, 7c,9c-phthalate (linear and branched), diisoctyl phthalate, linear 6c,8c,10c phthalate, diisononyl phthalate, linear 8c-10c phthalate, linear 7c-11c phthalate, diisodecyl phthalate, linear 9c-11c phthalate, diundecyl phthalate, diisodecyl glutarate, di-2-ethylhexyl adipate, di-2-ethylhexyl azelate, di-2-ethylhexyl sebacate, di-n-butyl sebacate, diisodecyl adipate, triethylene glycol caprate-caprylate, triethylene glycol 2-ethylhexanote, dibutoxyethyl adipate, dibutoxyethoxyethyl adipate, dibutoxyethoxyethyl formal, dibutoxyethoxyethyl sebacate, tri-2-ethylhexyl trimellitate, tri-(7c-9c (linear)) trimellitate, tri-(8c-10c (linear)) trimellitate, triethyl phosphate, triisopropyl phenyl phosphate, tributyl phosphate, 2-ethylhexyl diphenyl phosphate, trioctyl phosphate, isodecyl diphenyl phosphate triphenyl phosphate, triaryl phosphate synthetic, tributoxyethyl phosphate, tris(-chloroethyl) phosphate, butylphenyl diphenyl phosphate, chlorinated organic phosphate, cresyl diphenyl phosphate, tris(dichloropropyl) phosphate, isopropylphenyl diphenyl phosphate, trixylenyl phosphate, tricresyl phosphate, diphenyl octyl phosphate. Combinations of plasticizers are useful.

Other Additives

Either or both parts may contain additional additives, such as fillers, lubricants, thickeners, and coloring agents. The fillers provide bulk without sacrificing strength of the adhesive and can be selected from high or low density fillers.

Of particular interest are low density fillers, because the resulting final product has an otherwise lower density than a product without the filler, yet has essentially the same strength characteristics as if the filler was not present.

Silsesquioxanes

The silsesquioxanes are polyhedral oligomeric silsesquioxane materials (“POSS”). POSS materials may be represented by the formula [RSiO_{1.5}]∞, where ∞ is the degree of polymerization within the material and R is an organic substituent which may be selected from H, OH, and cyclic or linear aliphatic or aromatic groups that may additionally contain reactive functionalities such as alcohols, esters, amines, ketones, olefins, ethers or halides. POSS materials may include combinations of organic substituents and/or reactive functionalities thereon.

For example, R may be an organic substituent selected from H, OH, cyclic or linear aliphatic or aromatic groups that may additionally contain reactive functionalities such as alcohols, esters, amines, ketones, olefins, ethers or halides. Desirably, R is selected from (meth)acryl, (meth)acryloxyalkyl, hydroxy, cyclohexyl, cyclohexylalkyl, phenyl, linear or branched C₁₋₁₀ alkyl, alkyl C₁₋₁₀ silanes, silanol alkyl C₁₋₁₀, aminoalkyl C₁₋₁₀, glycidyl, glycidyl (meth)acrylate and combinations thereof.

Polysilsesquioxanes may be either homoleptic or heteroleptic. Homoleptic systems contain only one type of R group while heteroleptic systems contain more than one type of R group. Non-limiting examples of POSS nanostructure materials useful in the present invention may be represented by the formulas:
1. [(RSiO_{1.5})ₙ]_{Σ#} for homoleptic compositions;
2. [(RSiO_{1.5})ₘ(R′SiO_{1.5})ₙ]_{Σ#} for heteroleptic compositions;
3. [(RSiO_{1.5})ₘ(RXSiO_{1.0})ₙ]_{Σ#} for functionalized homoleptic compositions;
4. [(RSiO_{1.5})ₘ(R′SiO_{1.5})(RXSiO_{1.0})ₚ]_{Σ#} for functionalized heteroleptic compositions; and
5. (XsiO_{1.5})ₙ]_{Σ#} for homoleptic silicate compositions.

In all of the above formulas, R is the same as previously defined above; X includes but is not limited to OH, Cl, Br, I, alkoxide (OR), acetate (OOCR), peroxide (OOR), amine (NR₂) isocyanate (NCO), and R; the symbols m and n refer to the stoichiometry of the composition; the symbol Σ indicates that the composition forms a nanostructure and the symbol # refers to the number of silicon atoms contained within the nanostructure. The value for # is usually the sum of m+n. It should be noted that Σ# is not to be confused as a multiplier for determining stoichiometry, as it merely describes the overall nanostructural characteristics of the POSS system. The cage geometry may take a variety of forms including, without limitation, 5, 6, 7, 8, 9, 10, 12 and 16 cornered structures. For example, see U.S. Pat. No. 6,972,312, which is incorporated herein by reference, for examples of useful caged geometry. Fragments of caged structures may also be useful.

In one aspect of the invention the POSS materials conform to the general structures I and II below:

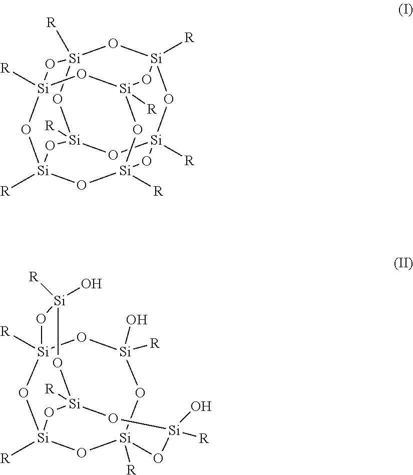

where R is as an organic substituent selected from H, OH, cyclic or linear aliphatic or aromatic groups that may additionally contain reactive functionalities such as alcohols, esters, amines, ketones, olefins, ethers or halides. Desirably, R is selected from (meth)acryloxyalkyl, OH, cyclohexyl, cyclohexylalkyl(C₁₋₁₀), phenyl, linear or branched alkyl (C₁₋₁₀), alkenyl (C₂₋₁₀), alkyl (C₁₋₁₀) silanes, silanolalkyl (C₁₋₁₀) aminoalkyl glycidyl, glycidyl (meth)acrylate, vinyl (C₂₋₁₀) and combinations thereof.

More specifically, silsesquioxanes having the following structures have been found to provide enhanced adhesive properties in the compositions of the present invention:

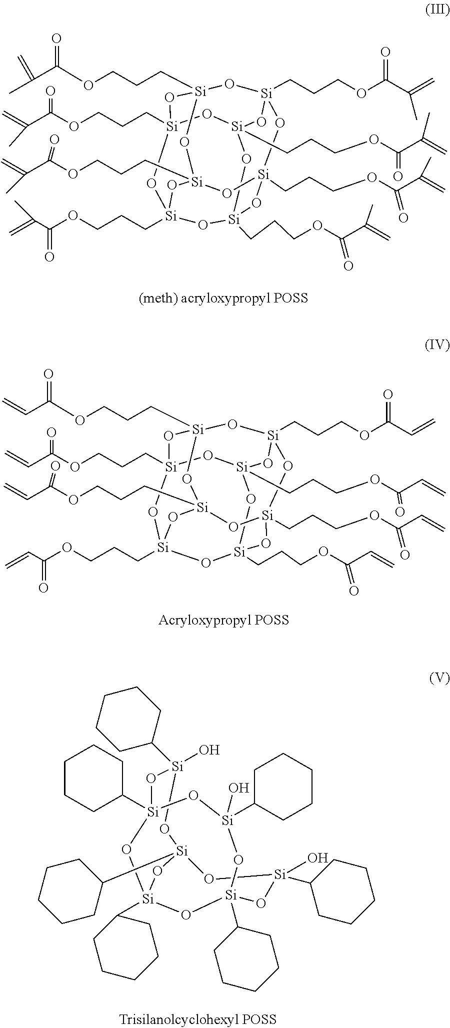

POSS may be employed in the adhesive compositions in amounts useful to enhance the adhesive properties of the compositions. For example, they may be present in amounts of about 0.1% to about 5% by weight of the total composition. More than one POSS may be used in a particular adhesive composition.

Packaging and Mixing

When prepared in a two part configuration, each of parts (A) and (B) are packaged in separate containers, such as bottles, cans, tubes, or drums.

Parts (A) and (B) are mixed in a ratio of about 1 to 10 parts (a) to about 10 to about 1 part (b). Desirably, the ratio of parts (A) to (B) is about 1 part (A) to about one part (B).

The mixing of the two parts can employ a mixing nozzle, which has fluid inputs for the two components, performs a suitable mixing operation, and dispenses the adhesive mixture directly onto the surface to be bonded. An example of a commercially available mixing and dispensing device are sold under the MIXPAC® trademark, by Sulzer Mixpac, Salem, N.H. The two parts can also be mixed manually in a bowl; bucket, or the like, but the operator needs to ensure that the mixing is thorough. As an aid to ensuring that mixing is complete, each part can be formulated with a dye or pigment, so that after mixing, a third color is formed. For example, one part may have a yellow dye, the other part may have a blue dye, so that after mixing, the complete adhesive composition will be green.

The inventive compositions are excellent adhesives and sealants. On application to a first surface, such as a sheet of metal, fabric or plastic that can be incorporated into a laminated material, a second surface will be mated with the first surface and the two surfaces will be bonded together as the adhesive cures. A further advantage is that no surface preparation is required to bond clean substrates.

By the term “curing” is meant that the chemical reaction converting the fluid mix to the solid bond of this invention. The curing process of this composition is exothermic, and may reach a temperature of about 120° C. or so, when a large bead of adhesive is used.

After mixing, the adhesive compositions fully cure in about 20 minutes at about 80° C. and within about 24 hours at room temperature. Fixture times range from about 7 to about 10 minutes, at which time the bond will support a 3 Kg load.

### EXAMPLES

The following two part adhesive compositions were prepared from the constituents as set forth in Table I below. Part A was prepared by mixing together the components in the amounts (phr) as listed to form a homogeneous blend, using mixing speeds of about 2500 RPMs for about 2-3 minutes. Part B was similarly separately formed. Here, Part A contains the silsesquioxane.

TABLE I

| | | | | | | | | | | | Part |
|---|---|---|---|---|---|---|---|---|---|---|---|
| | Part A⁷ | | | | | | | | | | B⁷ |
| Component | Control | 1a | 1b | 1c | 2a | 2b | 2c | 3a | 3b | 3c | B¹ |
| Methyl | 100 | 100 | 100 | 100 | 100 | 100 | 100 | 100 | 100 | 100 | 100 |
| Methacrylate | | | | | | | | | | | |
| Block | 25.1 | 25.1 | 25.1 | 25.1 | 25.1 | 25.1 | 25.1 | 25.1 | 25.1 | 25.1 | 49.1 |
| Copolymer | | | | | | | | | | | |
| Methacrylic | 6 | 6 | 6 | 6 | 6 | 6 | 6 | 6 | 6 | 6 | |
| acid | | | | | | | | | | | |
| Silica | 9.8 | 9.8 | 9.8 | 9.8 | 9.8 | 9.8 | 9.8 | 9.8 | 9.8 | 9.8 | 11.6 |
| Organic | 3.5 | 3.5 | 3.5 | 3.5 | 3.5 | 3.5 | 3.5 | 3.5 | 3.5 | 3.5 | — |
| Peroxide | | | | | | | | | | | |
| (CHP) | | | | | | | | | | | |
| Metal Salt² | — | — | — | — | — | — | — | — | — | — | 1.8 |
| Triphenyl | — | — | — | — | — | — | — | — | — | — | 0.9 |
| phosphine | | | | | | | | | | | |
| Amine | — | — | — | — | — | — | — | — | — | — | 7.3 |
| accelerator³ | | | | | | | | | | | |
| TC POSS⁴ | | 0.5 | 1.0 | 2.0 | 0.5 | 1.0 | 2.0 | 0.5 | 1.0 | 2.0 | — |
| Methacryloxy- | — | 0.5 | 1.0 | 2.0 | 0.5 | 1.0 | 2.0 | 0.5 | 1.0 | 2.0 | — |
| propyl | | | | | | | | | | | |
| POSS⁵ | | | | | | | | | | | |
| Acryloxy- | — | 0.5 | 1.0 | 2.0 | 0.5 | 1.0 | 2.0 | 0.5 | 1.0 | 2.0 | — |
| propyl POSS⁶ | | | | | | | | | | | |

¹Part B was used in conjunction with each of the Part A formulations (Control; 1a, 1b, 1c; 2a, 2b, 2c and 3a, 3b, 3c)
²Cu (II) salt in HEMA
³alkyl substituted dihydropyridine (PDHP)
⁴trisilanolcyclohexyl BOSS sold under the commercial name SO1400 by Hybrid Plastics, Inc.
⁵Sold under the commercial name MA0735 Methacryl POSS by Hybrid Plastics, Inc.
⁶Sold under the commercial name MA0736 Acrylo POSS by Hybrid Plastics, Inc.
⁷Parts Per Hundred

Parts A and B were mixed together in a ratio of 1:1 using a MIXPAC-brand nozzle set. The mixed adhesive composition was applied to lap shear specimens (of the material specified below) 1″ by 0.5″ with a 0.5″ overlap and a bondline of about 30 mil. For cross bond testing the lapshears were overlapped by forming a cross. The glass block specimens were tested in sheer. All other tests were tensile tests, as indicated. The results of the tests are shown in the Figures.

The test results illustrated in FIG. 1 used IXEF (polyacrylamide reinforced with glass fibre) lap shears as the substrate. The cross bond tests indicate that the use of the three POSS materials at each of three amounts (0.5, 1.0 and 2.0 percent by weight), significantly improved the strength (measured in in./lbs), as compared to the same formulation (control) without any POSS additive. The test results are tabulated in Table 1 below.

TABLE 1

| | 0 | 0.25 | 0.5 | 1.0 |
|---|---|---|---|---|
| Control | 72.12 | — | — | — |
| TC POSS | — | 99 | 86 | 129 |
| Methacryl | — | 130 | 100 | 122 |
| POSS | | | | |
| Acrylo | — | 156 | 168 | 158 |
| POSS | | | | |

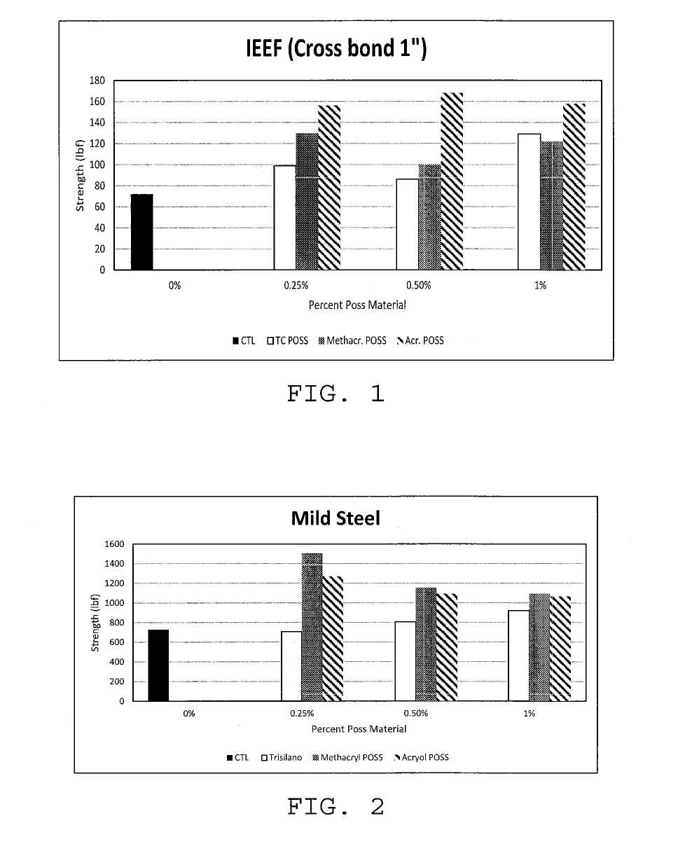

FIG. 2 shows the results of lap shear tensile testing on mild steel. In these tests the compositions containing TC POSS at levels of 0.25 percent by weight were comparable to the control (control: 726 in./lbs vs. composition made with part A 1a: 708 in./lbs), but when used at levels of 0.5 and 1.0 percent by weight compositions made with part A 1b and 1c demonstrated substantially better tensile strengths as indicated. The results are tabulated in Table 2 below.

TABLE 2

| | 0 | 0.25 | 0.5 | 1.0 |
|---|---|---|---|---|
| Control | 726 | — | — | — |
| TC POSS | — | 708 | 807 | 921 |
| Methacryl | — | 1503 | 1156 | 1093 |
| POSS | | | | |
| Acrylo | — | 1268 | 1093 | 1067 |
| POSS | | | | |

FIG. 3 shows the results of lap shear tensile testing on stainless steel. The results, tabulated in Table 3 below indicate the enhanced tensile strength achieved by the inventive compositions using the POSS additives as compared to the control.

TABLE 3

| | 0 | 0.25 | 0.5 | 1.0 |
|---|---|---|---|---|
| Control | 1025 | — | — | — |
| TC POSS | — | 1052 | 1421 | 1197 |
| Methacryl | — | 1492 | 1431 | 1082 |
| POSS | | | | |
| Acrylo | — | 1440 | 1082 | 1148 |
| POSS | | | | |

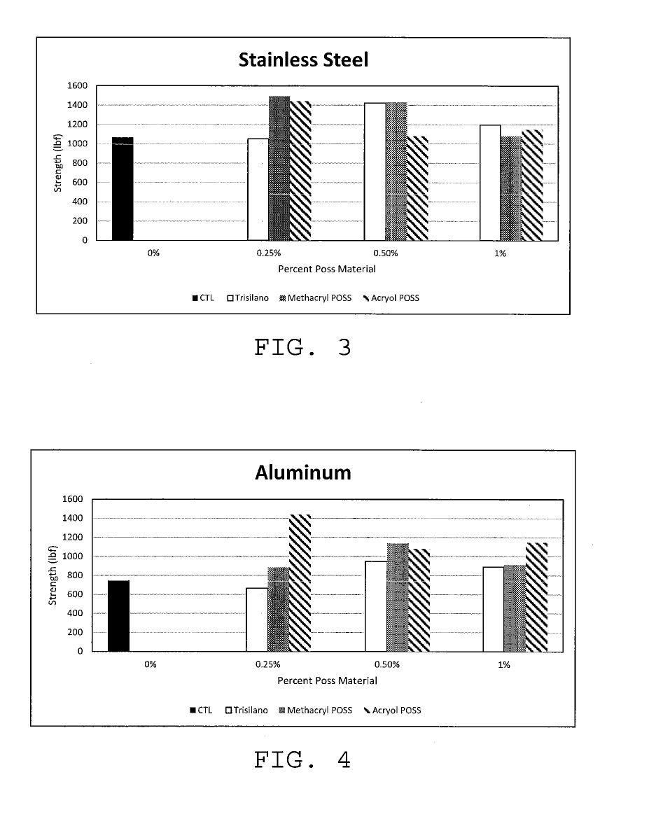

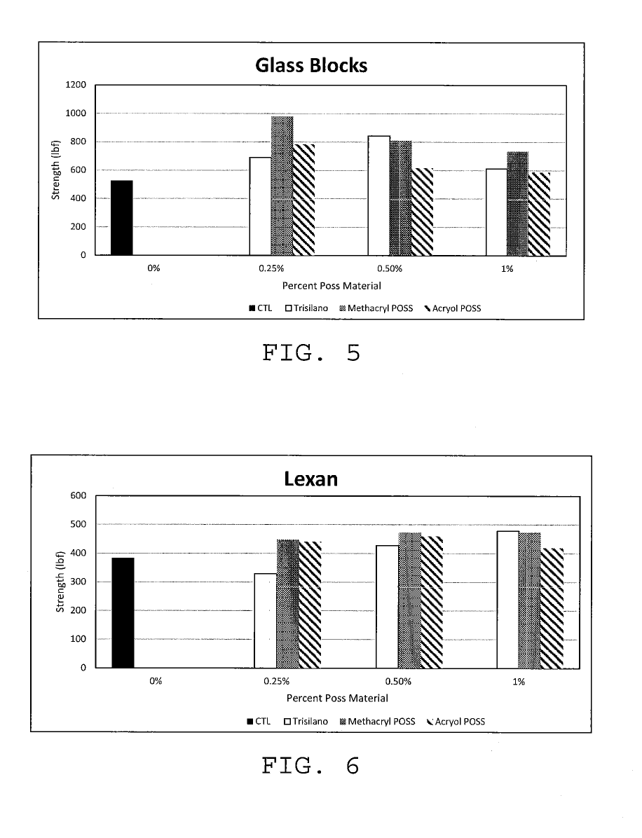

FIG. 4 shows the results of lap shear tensile testing on Aluminum. The results, tabulated in Table 4 below indicate the enhanced tensile strength achieved by the inventive compositions using the POSS additives as compared to the control.

TABLE 4

| | 0 | 0.25 | 0.5 | 1.0 |
|---|---|---|---|---|
| Control | 743 | — | — | — |
| TC POSS | — | 663 | 948 | 898 |
| Methacryl | — | 882 | 1139 | 913 |
| POSS | | | | |
| Acrylo | — | 1440 | 1082 | 1148 |
| POSS | | | | |

FIG. 5 shows the results of lap shear sheer testing on glass blocks. The results, tabulated in Table 5 below indicate the enhanced shear strength achieved by the inventive compositions using the POSS additives as compared to the control.

TABLE 5

| | 0 | 0.25 | 0.5 | 1.0 |
|---|---|---|---|---|
| Control | 526 | — | — | — |
| TC POSS | — | 691 | 843 | 612 |
| Methacryl | — | 979 | 810 | 724 |
| POSS | | | | |
| Acrylo | — | 783 | 617 | 588 |
| POSS | | | | |

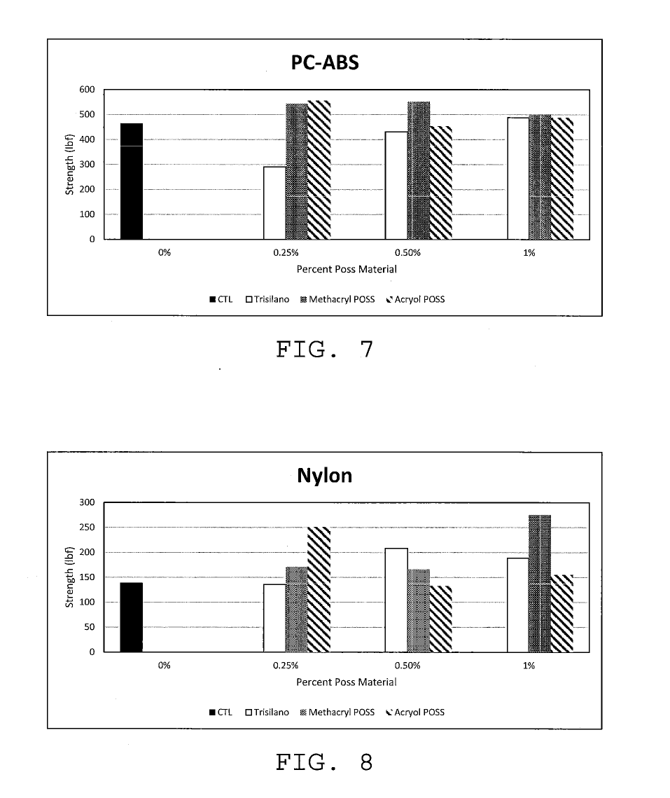

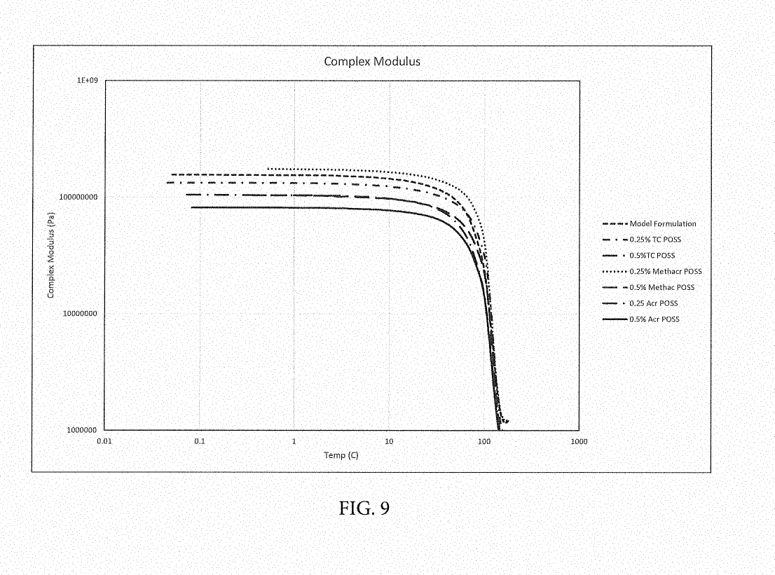

FIG. 6 shows the results of lap shear tensile testing on Lexan (polycarbonate). The results, tabulated in Table 6 below, indicate the enhanced tensile strength achieved by the inventive compositions using the POSS additives as compared to the control.

TABLE 6

| | 0 | 0.25 | 0.5 | 1.0 |
|---|---|---|---|---|
| Control | 383 | — | — | — |
| TC POSS | — | 328 | 428 | 478 |
| Methacryl | — | 448 | 473 | 474 |
| POSS | | | | |
| Acrylo | — | 441 | 460 | 419 |
| POSS | | | | |

FIG. 7 shows the results of lap shear tensile testing on PC-ABS. The results, tabulated in Table 7 below indicate the enhanced tensile strength achieved by the inventive compositions using the POSS additives as compared to the control.

TABLE 7

| | 0 | 0.25 | 0.5 | 1.0 |
|---|---|---|---|---|
| Control | 465 | — | — | — |
| TC POSS | — | 290 | 428 | 488 |
| Methacryl | — | 544 | 552 | 501 |
| POSS | | | | |
| Acrylo | — | 557 | 454 | 488 |
| POSS | | | | |

FIG. 8 shows the results of lap shear tensile testing on nylon. The results, tabulated in Table 8 below indicate the enhanced tensile strength achieved by the inventive compositions using the POSS additives as compared to the control.

TABLE 8

| | 0 | 0.25 | 0.5 | 1.0 |
|---|---|---|---|---|
| Control | 139 | — | — | — |
| TC POSS | — | 136 | 208 | 189 |
| Methacryl | — | 171 | 166 | 275 |
| POSS | | | | |
| Acrylo | — | 251 | 133 | 156 |
| POSS | | | | |

The following two part adhesive compositions were prepared from the constituents as set forth in Table II below. Part B was prepared by mixing together the components in the amounts (in phr) as listed to form a homogeneous blend, using mixing speeds of about 2500 RPMs for about 2-3 minutes. Part B was similarly separately formed. Here, Part B contains the silsesquioxane.

TABLE II

| | Part A | Part B | | |
|---|---|---|---|---|
| Component | A | Control | 1a | 1b |
| Methyl | 69.29 | 58.59 | 58.34 | 58.34 |
| Methacrylate | | | | |
| Block | 17.36 | 28.76 | 28.76 | 28.76 |
| Copolymer | | | | |
| Methacrylic | 4.15 | — | — | — |
| acid | | | | |
| Silica | 6.78 | 6.79 | 6.79 | 6.79 |
| Organic | 2.42 | — | — | — |
| Peroxide | | | | |
| (CHP) | | | | |
| Metal Salt^{✓} | — | 1.07 | 1.07 | 1.07 |
| Triphenyl | — | 0.53 | 0.53 | 0.53 |
| phosphine | | | | |
| TC POSS⁺ | — | — | — | 0.25 |
| Methacryloxy- | — | — | 0.25 | — |
| propyl POSS^{x} | | | | |

^{✓}Cu (II) salt in HEMA
⁺trisilanolcyclohexyl POSS sold under the commercial name SO1400 by Hybrid Plastics, Inc.
^{x}Sold under the commercial name MA0735 Methacryl POSS by Hybrid Plastics, Inc.

As before, parts A and B were mixed together in a ratio of 1:1 using a MIXPAC-brand nozzle set. The mixed adhesive composition was applied to lap shear specimens (constructed of the material specified below in Tables 9 and 10) in a geometry of 1″ by 0.5″ with a 0.5″ overlap and a bondline of about 30 mil. For the cross bond testing, the lapshears were overlapped by forming a cross. The glass block specimens were tested for shear strength. See Table 9 below.

TABLE 9

| | Part B | | |
|---|---|---|---|
| Substrate | Control | 1a | 1b |
| Mild Steel | 726 | 1568 | 1750 |
| STAINLESS-STEEL | 1025 | 1474 | 1591 |
| Aluminium | 743 | 1567 | 1253 |
| NYLON | 139 | 147 | 166 |
| PC-ABS | 465 | 612 | 619 |
| POLY-CARB | 383 | 497 | 511 |
| (Lexan) | | | |
| Push test IXEF | 72.12 | 144 | 158 |

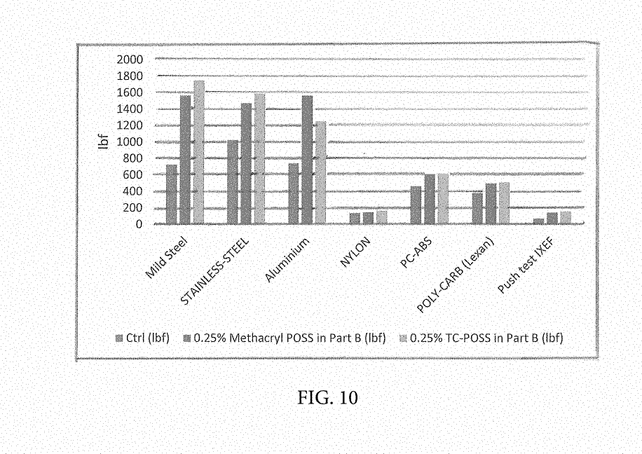

FIG. 10 shows the results (in lbf) of lap shear tensile testing on various substrates. Table 10 below captures this data in tabular format.

TABLE 10

| | Part B | | |
|---|---|---|---|
| Substrate | Control | 1a | 1b |
| T_SHEAR_Mild Steel | 1568 | 1750 | 726 |
| T_SHEAR_STAINLESS-STEEL | 1474 | 1591 | 1025 |
| T_SHEAR_Aluminium | 1567 | 1253 | 743 |
| T_SHEAR_IXEF | 864 | 777 | |
| T_SHEAR_NYLON | 147 | 166 | 139 |
| T_SHEAR_PC-ABS | 612 | 619 | 465 |
| T_SHEAR_POLY-CARB | 497 | 511 | 383 |
| (Lexan) | | | |
| X-HATCH_IXEF | 144 | 158 | 72.12 |

What is claimed is:

1. An adhesive composition in a two part configuration comprising:
(a) a first part comprising a (meth)acrylic component and an organic peroxide; and
(b) a second part comprising a (meth)acrylic component, a nitrogen-containing compound and a metal salt, wherein at least one of the first part or the second part further comprises a silsesquioxane.

2. The composition of claim 1, wherein the silsesquioxane comprises one or more (meth)acryl groups attached thereto.

3. The composition of claim 1, wherein the silsesquioxane comprises the structure: 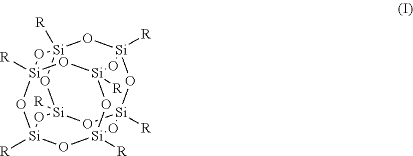
wherein one or more R groups is a (meth)acryloxyakyl group.

4. The composition of claim 2, wherein the R group is (meth)acryloxypropyl.

5. The composition of claim 1, wherein the silsesquioxane comprises the structure (II): 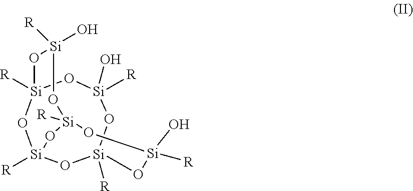
wherein R is a cyclohexyl group.

6. The composition of claim 1, wherein the (meth)acrylic component of at least one of the first part (A) or the second part (B) is selected from the group consisting of methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(meth)acryloyloxypropyl trimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate, ethoxylated trimethylolpropane triacrylate, trimethylol propane trimethacrylate, dipentaerythritol monohydroxypentacrylate, pentaerythritol triacrylate, ethoxylated trimethylolpropane triacrylate, 1,6-hexanedioldiacrylate, neopentyl glycoldiacrylate, pentaerythritol tetraacrylate, 1,2-butylene glycoldiacrylate, trimethylopropane ethoxylate tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate, ethoxylated bisphenol A di(meth)acrylate, and combinations thereof.

7. The adhesive composition of claim 1, further comprising a block copolymer.

8. The composition of claim 1, wherein the silsesquioxane is present in Part A.

9. The composition of claim 1, wherein the silsesquioxane is present in Part B.

10. A method of preparing a two-part adhesive composition comprising:
(a) forming a first part (A) comprising a (meth)acrylic acid component and an organic peroxide; and
(b) forming a second part (B) comprising a (meth)acrylic acid component, a nitrogen-containing component and a metal salt, wherein at least one of the first part or the second part further comprises a silsesquioxane.

11. The method of claim 10, wherein the silsesquioxane comprises one or more (meth)acryloxyalkyl groups attached thereto.

12. The method of claim 10, wherein the organic portion of the silsesquioxane comprises cyclohexyl groups and silanol groups.

13. A method of bonding a first surface to a second surface, comprising:
providing a two part composition comprising:
(a) a first part (A) comprising a (meth)acrylic component and an organic peroxide; and
(b) a second part (B) comprising a (meth)acrylic component, a nitrogen-containing compound and a metal salt, wherein at least one of the first part or the second part further comprises a silsesquioxane;
where providing a first surface and a second surface in a mating relationship and disposing the composition between the mated surfaces, wherein when the surfaces are mated they will have a cure time of about 20 minutes or less at 80° C.; and a fixture time of less than 5 minutes at which the bond will support 3 Kg.

14. The method of claim 13, wherein the silsesquioxane comprises one or more (meth)acryloxyakyl groups attached thereto.

15. The method of claim 13, wherein the first part and second are mixed in a ratio of 1:10 to 10:1 part (A) to part (B) by volume.

16. An adhesive composition comprising:
(a) a (meth)acrylic component;
(b) a curative package comprising an organic peroxide, a nitrogen-containing compound and a metal salt; and
(c) a silsesquioxane.

17. The composition of claim 16, wherein the silsesquioxane comprises one or more (meth)acryloxyalkyl groups attached thereto.

18. The composition of claim 16, wherein the silsesquioxane comprises the structure: 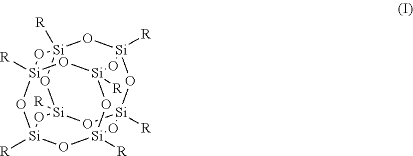
wherein one or more R groups is a (meth)acryloxyalkyl group.

19. The composition of claim 18, wherein the silsesquioxane comprises silanol groups and cyclohexyl groups.

20. The composition of claim 16, wherein the silsesquioxane comprises the formula: 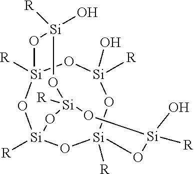
wherein R is a cyclohexyl group.

21. The adhesive composition of claim 16, further comprising a block copolymer.

22. The composition of claim 16, wherein the (meth)acrylic component is selected from the group consisting of methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(meth)acryloyloxypropyl trimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfIuorohexylethyl (meth)acrylate, 2-perfluorodecylethyl (meth)acrylate, 2-perfluorohexadecylethyl (meth)acrylate, ethoxylated trimethylolpropane triacrylate, trimethylol propane trimethacrylate, dipentaerythritol monohydroxypentacrylate, pentaerythritol triacrylate, ethoxylated trimethylolpropane triacrylate, 1,6-hexanedioldiacrylate, neopentyl glycoldiacrylate, pentaerythritol tetraacrylate, 1,2-butylene glycoldiacrylate, trimethylopropane ethoxylate tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate, ethoxylated bisphenol A di(meth)acrylate, and combinations thereof.

23. The composition of claim 16, further comprising a reactive acid component.

24. The composition of claim 23, wherein the reactive acid component is (meth)acrylic acid.

25. The composition of claim 23, wherein the reactive acid component is sulphonic acid or sulphonic acid derivatives, phosphoric acid, phosphoric acid derivatives, and phosphate esters, or acrylic acid.
